(19) United States
(12) Patent Application Publication
(10) Pub. No.: US 2013/0195522 A1
(43) Pub. Date: Aug. 1, 2013

(54) FIXING DEVICE AND IMAGE FORMING APPARATUS

(71) Applicant: Kyocera Document Solutions Inc., Osaka (JP)

(72) Inventor: Kenichi KASAMA, Osaka (JP)

(73) Assignee: KYOCERA DOCUMENT SOLUTIONS INC., Osaka (JP)

(21) Appl. No.: 13/746,584

(22) Filed: Jan. 22, 2013

(30) Foreign Application Priority Data
Jan. 30, 2012 (JP) 2012-016252

(51) Int. Cl. G03G 15/20

(52) U.S. Cl. CPC G03G 15/2064
USPC 399/329

(57) ABSTRACT

A fixing device includes: a fixing belt; a heat portion; a pressure roller; a push member that pushes the fixing belt against the pressure roller; and a push pad that is disposed on a surface of the push member that opposes the fixing belt. A slide surface of the push pad has a flat portion substantially parallel to a convey direction of the recording medium and an arc-shaped portion that bends toward the pressure roller in a more downstream side than the flat portion in the recording medium convey direction, the arc-shaped portion includes a radius R2 of curvature larger than a radius R1 of curvature of the pressure roller and a center O2 of curvature that is situated in a more upstream side than a straight line which passes a center O1 of curvature of the pressure roller and is perpendicular to the recording medium convey direction.

### INCORPORATION BY REFERENCE

This application is based on and claims the benefit of priority from Japanese Patent Application No. 2012-16252 filed on Jan. 30, 2012, the contents of which are hereby incorporated by reference.

### BACKGROUND

The present disclosure relates to a fixing device of belt fixing type in which a paper sheet carrying an unfixed toner image is inserted into a fixing nip portion formed by a heated fixing belt and a pressure member, and the unfixed toner is heated, melted, and fixed onto the paper sheet, and to an electro-photographic image forming apparatus including the fixing device.

In an conventional image forming apparatus of the electro-photographic type, a heat roller fixing type is widely used, in which a heat roller is composed by incorporating a heat source into at least one of a pair of fixing rollers that form a fixing nip portion, and a paper sheet carrying an unfixed toner image is inserted into the fixing nip portion to fix the toners onto the paper sheet.

In this heat roller fixing type, heat transmission efficiency from the heat source such as a halogen lamp and the like incorporated in the heat roller to a surface of the roller is low, and a heat loss is large. Besides, it takes a long time for the heat to travel to the roller surface. As a result of this, there are problems that because heat efficiency is poor, power consumption is large and it takes a long warmup time for the roller surface to reach a temperature which allows the fixing.

Besides, in a case where a hard roller obtained by coating a metal cylinder surface with a fluororesin is used as the heat roller and a rubber roller is used as the pressure roller, a sectional shape of the nip portion (fixing nip portion) of the pair of rollers becomes an arc shape convex toward the pressure roller. Accordingly, water content evaporates thanks to the heating, and a paper sheet curled toward the heat roller is further curled by the nip shape to become a cylindrical shape. Conversely, in a case where the rubber roller is used for the heat roller and the hard roller is used for the pressure roller, there is a risk that during a both-side printing time when toners are present on a rear surface of the paper sheet, the paper sheet clings to the pressure roller and a jam occurs. On the other hand, in a structure where the rubber roller is used for both of the heat roller and the pressure roller, the sectional shape of the fixing nip portion becomes linear and the curl of the paper sheet becomes unlikely to occur, however, in documents such as an envelope, a letter including a plurality of paper sheets overlapping one another and the like in which two or more paper sheets overlap, there is a problem that the paper sheets deviates and a crumple occurs.

To solve the above problems, a belt fixing type is developed, in which as a heat member for heating a paper sheet, instead of a heat roller, an endless fixing belt which absorbs radiant light from a heat generation source and generates heat is used, and a paper sheet carrying an unfixed toner image is inserted into a fixing nip portion that is formed by the fixing belt and the pressure member, whereby the toners are fixed onto the paper sheet. In this belt fixing type, compared with the heat roller fixing type, it is possible to make the heat capacity small, shorten the warmup time, and reduce the power consumption.

As driving methods of the fixing belt, there known are a structure where a flange-shaped end cap member is secured to both ends in a rotary shaft direction of an endless fixing belt and the fixing belt is driven via a gear that is formed in the end cap member; and a structure where a fixing belt is driven by using a tension roller that is disposed at a downstream position with respect to the nip portion of an inside of an endless fixing belt.

However, in the above method for directly driving the fixing belt, it is necessary to rotate push members such as the end cap member, the tension roller and the like disposed in the inside of the fixing belt, accordingly, it is hard to freely set the shape and width of the nip portion.

Besides, generally, as methods for widening the nip width, there known are a method which uses a large-diameter pressure roller; a method which increases a rubber thickness of a surface of the pressure roller or lowers a rubber hardness degree of the pressure roller; and a method which raises a push force of the pressure roller. However, there are risks that the large diameter of the pressure roller could cause size increase and cost rise of the fixing device and the increase in the rubber thickness could cause extension of the warmup time. Besides, an outer-diameter change due to a temperature becomes large, accordingly, the lowering of the rubber harness causes a decline of a conveyance performance, and durability also declines. Further, the increase in the push force of the pressure roller leads to the decline of the conveyance performance due to an excessive bend amount of the roller surface and to the cost rise due to a fixing frame reinforcement.

To avoid this, a slide belt fixing type is devised, in which a belt support member is disposed in the inside of the fixing belt; the pressure roller is pushed from outside the fixing belt to contact the belt support member; and the belt support member and the inside surface of the fixing belt are slid by using frictional force between the pressure roller and the outer surface of the fixing belt to rotate and drive the fixing belt. In the slide belt type, the shape of the belt support member is formed into a flat surface shape or a small-curvature R shape, whereby a wide nip width is obtainable by using a low push force.

In the above slide belt fixing type, it is necessary to separate a paper sheet from the surface of the fixing belt in a downstream side in a paper sheet convey direction with respect to the nip portion between the belt support member and the pressure roller. Especially, in a case where color printing that uses a large ink amount is performed onto a paper sheet that has weak resilience, it becomes hard to separate the paper sheet from the surface of the fixing belt.

To avoid this, the shape and material of a push pad disposed on a surface of the belt support member that contacts the fixing belt are studied, and a fixing device is known, in which for example, by using an elastic body for the push pad, the nip portion of the fixing belt is given a bend along an outer circumference of the pressure roller, whereby the curvature of the fixing belt in the downstream side of the fixing nip portion is enlarged and separation performance for the paper sheet is secured.

Besides, a fixing device is known, in which the push pad is formed of an elastic body and the curvature of the push pad is reversed in the nip portion to secure the paper sheet separation performance.

However, the above push pad used in the fixing device is used at the portion where heat and pressure are applied, accordingly, deformation of the fixing nip portion is liable to occur thanks to a bite of the push pad into the surface of the pressure roller. Because of this, there are problems that it is hard to keep the shape of the fixing nip portion over the service life of the fixing device and it is impossible to secure the paper sheet separation performance in the downstream side of the fixing nip portion.

### SUMMARY

A fixing device according to an aspect of the present disclosure includes an endless fixing belt, a heat portion, a pressure roller, a push member, and a push pad, wherein a recording medium is inserted into a fixing nip portion formed by the fixing belt and the pressure roller, whereby an unfixed toner image carried on the recording medium is fixed. The fixing belt is rotatable at a speed substantially equal to a convey speed of the recording medium. The heat portion heats the fixing belt. The pressure roller is disposed to oppose an outer circumferential surface of the fixing belt and gives a rotation-drive force to the fixing belt. The push member contacts an inside of the fixing belt to push the fixing belt against the pressure roller at a predetermined pressure. The push pad is disposed on a surface of the push member that opposes the fixing belt, includes a slide surface on which an inner circumferential surface of the fixing belt slides. The slide surface includes a flat portion substantially parallel to a convey direction of the recording medium and an arc-shaped portion that bends toward the pressure roller in a more downstream side than the flat portion in the convey direction with respect to the recording medium, the arc-shaped portion includes a radius R2 of curvature larger than a radius R1 of curvature of the pressure roller and a center O2 of curvature that is situated in a more upstream side than a straight line which passes through a center O1 of curvature of the pressure roller and is perpendicular to the convey direction of the recording medium; the pressure roller butts the arc-shaped portion via the fixing belt at a predetermined pressure to form the fixing nip portion.

An image forming apparatus according to an aspect of the present disclosure includes an image forming portion that forms a toner image, a transfer portion that transfers the toner image formed by the image forming portion onto a recoding medium as an unfixed toner image, and a fixing device. The fixing device includes an endless fixing belt, a heat portion, a pressure roller, a push member, and a push pad, wherein the recording medium is inserted into the fixing nip portion formed by the fixing belt and the pressure roller, whereby the unfixed toner image carried on the recording medium is fixed. The fixing belt is rotatable at a speed substantially equal to a convey speed of the recording medium. The heat portion heats the fixing belt. The pressure roller is disposed to oppose an outer circumferential surface of the fixing belt and gives a rotation-drive force to the fixing belt. The push member contacts an inside of the fixing belt to push the fixing belt against the pressure roller at a predetermined pressure. The push pad is disposed on a surface of the push member that opposes the fixing belt, includes a slide surface on which an inner circumferential surface of the fixing belt slides. The slide surface includes a flat portion substantially parallel to a convey direction of the recording medium and an arc-shaped portion that bends toward the pressure roller in a more downstream side than the flat portion in the convey direction with respect to the recording medium, the arc-shaped portion includes a radius R2 of curvature larger than a radius R1 of curvature of the pressure roller and a center O2 of curvature that is situated in a more upstream side than a straight line which passes through a center O1 of curvature of the pressure roller and is perpendicular to the convey direction of the recording medium; the pressure roller butts the arc-shaped portion via the fixing belt at a predetermined pressure to form the fixing nip portion.

Still other objects of the present disclosure and specific advantages obtained by the present disclosure will become more apparent from the following embodiments described hereinafter.

### BRIEF DESCRIPTION OF THE DRAWINGS

FIG. 1 is a schematic sectional view of an image forming apparatus 100 that incorporates a fixing device 16 according to the present disclosure.

FIG. 2 is a side sectional view of the fixing device 16 according to an embodiment of the present disclosure.

FIG. 3 is a plan view when viewing the fixing device 16 in the present disclosure from top of FIG. 2.

FIG. 4 is a side enlarged view around a fixing nip portion N in FIG. 3.

FIG. 5 is a side view showing another shape of a push pad 40 that is used in the fixing device 16 in the present disclosure.

### DETAILED DESCRIPTION

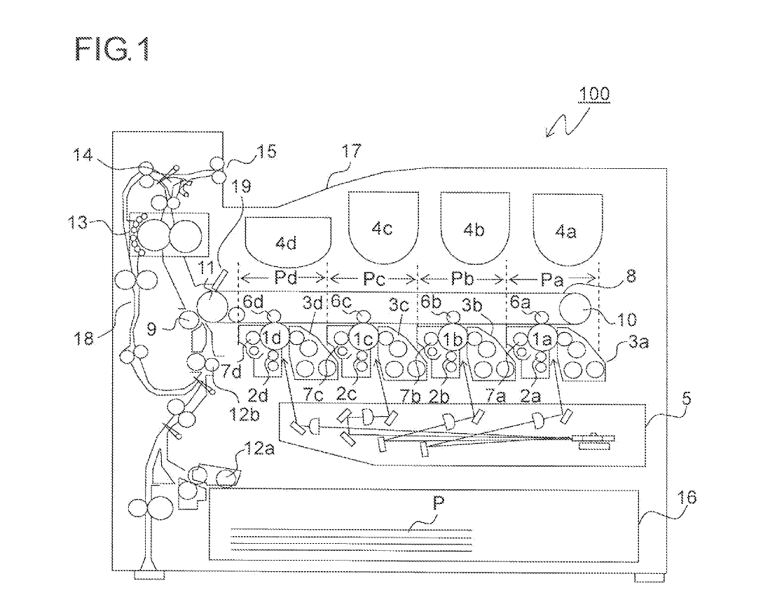

Hereinafter, an embodiment of the present disclosure is described with reference to the drawings. FIG. 1 is a schematic sectional view showing a structure of an image forming apparatus which incorporates a fixing device in the present disclosure. Here, as an example of the image forming apparatus, a color printer of tandem type is shown. In a main body of the color printer 100, four image forming portions Pa, Pb, Pc, and Pd are disposed successively in this order from an upstream side (right side in FIG. 1) in a convey direction. These image forming portions Pa to Pd are disposed to correspond to images of four different colors (magenta, cyan, yellow, and black), and respectively form the images of magenta, cyan, yellow, and black successively by the steps for electrifying, exposing, developing, and transferring.

In the image forming portions Pa to Pd, there are respectively disposed photosensitive drums 1a, 1b, 1c, and 1d for carrying visible images (toner images) of respective colors, and an intermediate transfer belt 8 rotated by a drive means (not shown) in a clockwise direction in FIG. 1 is disposed adjacently to each of the image forming portions Pa to Pd. Toner images formed on these photosensitive drums 1a to 1d are successively primarily transferred onto the intermediate transfer belt 8, which moves contacting each of the photosensitive drums 1a to 1d, and superimposed on one another. Thereafter, thanks to operation of a secondary transfer roller 9, the toner images are secondarily transferred onto a paper sheet P that is an example of a recording medium, further, are fixed onto the paper sheet P at a fixing device 13, and then ejected from the apparatus main body. The photosensitive drums 1a to 1d are rotated in a counterclockwise direction in FIG. 1, and the image forming process is applied to each of the photosensitive drums 1a to 1d.

The paper sheet P onto which the toner images are to be transferred is stored in a paper sheet cassette 16 that is disposed in a lower portion of the main body of the color printer 100. The paper sheet P is conveyed to a nip portion (transfer portion) formed between the secondary transfer roller 9 and a drive roller 11 for the intermediate transfer belt 8 described later via a sheet feeding roller 12a and a pair of registration rollers 12b. For the intermediate transfer belt 8, a dielectric resin sheet, that is, a (seamless) belt having no seam is mainly used. Besides, a blade-shaped belt cleaner 19 for removing toners and the like remaining on a surface of the intermediate transfer belt 8 is disposed in a downstream side with respect to the secondary transfer roller 9.

Next, the image forming portions Pa to Pd are described. Around and below the rotatably disposed photosensitive drums 1a to 1d, there disposed are: electrification devices 2a, 2b, 2c, and 2d for electrifying the photosensitive drums 1a to 1d; an exposure device 5 for directing light to each of the photosensitive drums 1a to 1d in accordance with image information; developing devices 3a, 3b, 3c, and 3d for forming a toner image on the photosensitive drums 1a to 1d; and cleaning portions 7a, 7b, 7c, and 7d for removing developer (toner) and the like remaining on the photosensitive drums 1a to 1d.

When image data are input from an upward apparatus such as a personal computer or the like, first, the electrification devices 2a to 2d evenly electrify surfaces of the photosensitive drums 1a to 1d. Next, the exposure device 5 directs light in accordance with the image data to form an electrostatic latent image corresponding to the image data on each of the photosensitive drums 1a to 1d. The developing devices 3a to 3d are each filled with a predetermined amount of two-component developer containing toners for the respective colors of magenta, cyan, yellow, and black. Meanwhile, in a case where the percentage of the toners in the two-component developer loaded in the respective developing devices 3a to 3d becomes lower than a predetermined value because of the forming of toner images described later, the respective developing devices 3a to 3d are supplied with toners from toner containers 4a to 4d. The toners in the developer are supplied onto the photosensitive drums 1a to 1d by the developing devices 3a to 3d, and the toners electrostatically adhere to the respective photosensitive drums 1a to 1d, whereby toner images, which correspond to the electrostatic latent images formed by the exposure performed by the exposure device 5, are formed.

And, by primary transfer rollers 6a to 6d, an electric field having a predetermined transfer voltage is given between the primary transfer rollers 6a to 6d and the photosensitive drums 1a to 1d, and the toner images of magenta, cyan, yellow, and black on the photosensitive drums 1a to 1d are primarily transferred onto the intermediate transfer belt 8. The toner images of four colors are formed to have a predetermined positional relationship that is predetermined for forming a predetermined full-color image. Thereafter, in preparation for the forming of new electrostatic latent images to be successively performed, the toners and the like remaining on the surfaces of the photosensitive drums 1a to 1d after the primary transfer are removed by the cleaning portions 7a to 7d.

The intermediate transfer belt 8 is mounted on the driven roller 10 in an upstream side and the drive roller 11 in a downstream side. When the intermediate transfer belt 8 starts to rotate in the clockwise direction in accordance with rotation of the drive roller 11 caused by a drive motor (not shown), the paper sheet P is conveyed from the pair of registration rollers 12b at a predetermined timing to the nip portion (secondary transfer nip portion) between the drive roller 11 and the secondary transfer roller 9 disposed adjacently to the drive roller 11. And, a full-color toner image on the intermediate transfer belt 8 is transferred onto the paper sheet P. The paper sheet P on which the toner image is transferred is conveyed to the fixing device 13.

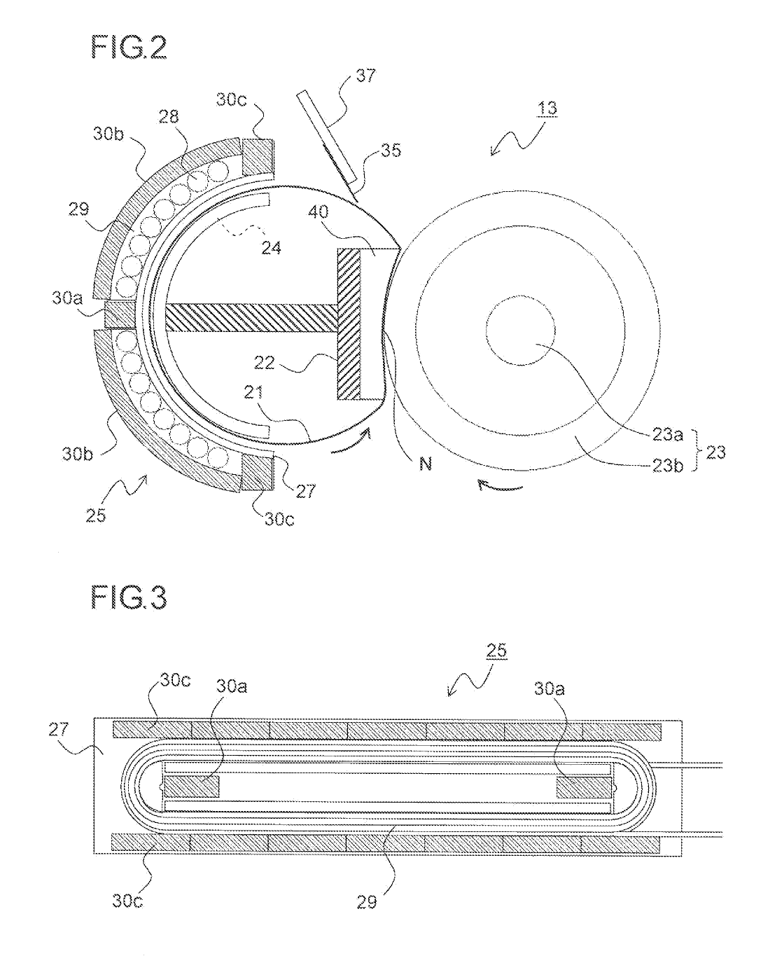

The paper sheet P conveyed to the fixing device 13 is heated and pressurized by a fixing belt 21 and a pressure roller 23 (see FIG. 2), and the toner images are fixed onto the surface of the paper sheet P to form the predetermined full-color image. The paper sheet P on which the full-color image is formed is switched in convey direction by a branch portion 14 that branches off into a plurality of directions. In a case where an image is formed on only one surface of the paper sheet P, the paper sheet P is ejected as it is to an ejection tray 17 by a pair of ejection rollers 15.

On the other hand, in a case where images are formed on both surfaces of the paper sheet P, the paper sheet P passing the fixing device 13 is temporarily conveyed toward the pair of ejection rollers 15. And, after a rear end of the paper sheet P passes through the branch portion 14, the pair of ejection rollers 15 are rotated reversely, and the convey direction of the branch portion 14 is switched. According to this, the paper sheet P is directed to a sheet reverse transport path 18 with the rear end being conveyed ahead, and is again conveyed to the secondary transfer nip portion under a state where the image surface is reversed. And, the next image formed on the intermediate transfer belt 8 is transferred by the secondary transfer roller 9 onto a surface of the paper sheet P on which no image is formed, and the paper sheet P is conveyed to the fixing portion 13, where the toner image is fixed, thereafter, ejected to the ejection tray 17.

FIG. 2 is a side sectional view of the fixing device 13 according to an embodiment of the present disclosure, and FIG. 3 is a plan view of an induction heat portion 25 used in the fixing device 13. As shown in FIG. 2, the fixing device 13 has a structure that includes an endless fixing belt 21 that rotates in the counterclockwise direction in FIG. 2; a push member 22 that contacts an inside of the fixing belt 21; a push pad 40 that is disposed on a surface of the push member 22 which opposes the fixing belt 21; a pressure roller 23 that is pushed against the push member 22 via the fixing belt 21 and the push pad 40 and rotates in the clockwise direction in FIG. 2; and the induction heat portion 25 (heat portion) that is disposed on a side opposite to the pressure roller 23 with the fixing belt 21 interposed.

The fixing belt 21 is an endless belt that is formed of a plurality of laminated layers each of which includes an induction heat generation layer disposed on the most inside that contacts the push pad 40 and a toner release layer disposed on the most outside that contacts the pressure roller 23. The fixing belt 21 is wound around the push member 22 and a support member 24 that has an arch shape in section and contacts an inside of the fixing belt 21 in a side (side opposite to the induction heat portion 25) opposite to the push member 22, and is given a predetermined tension. Further, a portion of the fixing belt 21 which does not contact the push member 22 (push pad 40) is held to be an arc shape that is away from the induction heat portion 25 by a predetermined gap. Meanwhile, instead of the support member 24, an arc-shaped flange portion, which protrudes from an inner surface of a fixing housing (not shown) and contacts insides of both end portions in a width direction of the fixing belt 21, may be disposed.

As the induction heat generation layer of the fixing belt 21, a metal layer obtained by plating or by applying a milling process to a metal such as nickel or the like is used. The toner release layer is formed by using a fluororesin such as PFA (tetrafluoroethylene-perfluoroalkylvinylether copolymer) or the like and by applying a paint to or covering the resin with a tube. It is suitable that the toner release layer has a thickness of about 10 to 50 μm in a case of the PFA tube and a thickness of about 10 to 30 μm in a case of the fluororesin paint.

Besides, as an elastic layer, a silicone rubber layer having a thickness of about 100 to 1000 μm may be disposed between the induction heat generation layer and the toner release layer. According to this structure, the elastic layer covers an unfixed toner image on a paper sheet to perform the fixing softly. As a result of this, it becomes possible to achieve high image quality and obtain the fixing device 13 that has high performance.

Besides, by disposing a heat storage layer between the induction heat generation layer and the toner release layer, it is also possible to prevent the heat generated by the induction heat generation layer from escaping and keep the surface temperature of the fixing belt 21 constant. As a result of this, it becomes possible to obtain higher heat efficiency and raise effects of shortening the warmup time and reducing the power consumption.

The heat storage layer is composed of a silicone rubber having a high heat conductivity in which powders of a metal oxide such as silica, alumina, a magnesium oxide or the like are mixed or of a metal such as aluminum, copper, nickel or the like that has a high heat conductivity, and made by forming them into a tube shape, applying coating to or plating the tube. There is not a problem if the heat storage layer is formed of an elastic material such as the silicone rubber or the like, however, in a case where the heat storage layer is composed of a metal, if the thickness is made too much, the belt hardness increases and a nip amount necessary for melting the toners becomes unobtainable. Accordingly, the thickness of the heat storage layer is formed to be 10 to 1000 μm, and desirably 50 to 500 μm.

As the structure of the fixing belt 21 used for the present embodiment, for example, there is an endless belt having an outer diameter of 20 to 50 mm which is obtained by laminating a silicone rubber layer (elastic layer) having a thickness of 100 to 500 μm onto a nickel layer having a thickness of 30 to 50 μm or onto a polyimide resin layer having a thickness of 50 to 100 μm in which metal powders of copper, silver, aluminum or the like are mixed (induction heat generation layer), and by covering it with a PFA tube (toner release layer) having a thickness of 30 to 50 μm. Besides, a polyimide layer or a polyamide layer excellent in wear resistance is disposed on a portion of an inner surface of the fixing belt 21 on which the push pad 40 slides.

Besides, a thermistor (not shown) is disposed to contact the surface of the fixing belt 21. The temperature of the fixing belt 21 is detected by using the thermistor, and control of the fixing temperature is performed by turning on/off an electric current that flows in the induction heat portion 25.

Besides, a dimension of the fixing belt 21 in the width direction (direction perpendicular to the paper surface of FIG. 2) is set to be narrower than a dimension of the induction heat portion 25 in the width direction and wider than the maximum paper sheet width that passes a fixing nip portion N. According to this, the induction heat portion 25 is capable of evenly heating the entire fixing belt 21 to prevent occurrence of uneven fixing and the fixing belt 21 is capable of covering the entire paper sheet surface irrespective of the paper sheet size, accordingly, it is possible to unfixed toners from adhering to the push member 22 and the push roller 31.

One end of the push member 22 is supported by the support member 24 and the other end butts the pressure roller 23 via the push pad 40 and the fixing belt 21, thereby forming the fixing nip portion N through which the paper sheet passes. As a material of the push member 22, a metal such as aluminum or the like or a heat resistant resin or the like is used.

The push pad 40 is composed of a heat resistant resin such as a liquid crystal polymer resin or the like or of an elastic material such as a silicone rubber or the like, and there also is a case where elastomer is disposed on an opposing surface that opposes the fixing belt 21. Besides, to reduce a slide load of a contact surface that contacts the fixing belt 21, a fluororesin slide member (not shown) such as a PTFE sheet or the like is interposed. Especially, by forming the push pad 40 by using the liquid crystal polymer resin excellent in heat resistance, it is possible to alleviate deformation of the push pad 40 due to the heating and pressurizing and keep the shape of the fixing nip portion N constant over a long time.

In the pressure roller 23, for example, an elastic layer 23b is disposed on an outside of a metal core 23a. The metal core 23a is provided with a pressure adjustment mechanism (not shown) that adjusts the pressure of the pressure roller 23. In the present embodiment, the pressure roller 23 having an outer diameter of 35 mm is used, in which a silicone rubber layer 23b, which has a thickness of 7.5 mm and composes the elastic layer, is disposed on the outside of the aluminum core metal 23a that has a diameter of 20 mm. The pressure roller 23 is rotated and driven clockwise by a not-shown drive motor. Meanwhile, the surface of the pressure roller 23 may be covered by a toner release layer such as a PFA tube or the like.

The induction heat portion 25 is intended to heat the fixing belt 21 by using electromagnetic induction, and is composed of a coil bobbin 27, a coil 29, and a core portion that includes a center core 30a, an arch core 30b, a side core 30c and the like. The induction heat portion 25 is disposed to enclose and oppose a portion of the arc-shaped outer surface of the fixing belt 21.

The coil bobbin 27 is formed into an arc shape in section along the outer surface of the fixing belt 21. It is preferable that a material of the coil bobbin 27 is a heat resistant resin (e.g., PPS: polyphenylenesulfide resin, PET: polyethylene terephthalate resin, LCP: liquid crystal polymer resin).

The coil 29, which is obtained by winding a litz wire, that is, a bundle of thin wires by a plurality of turns (here, 8 turns) in a longitudinal direction (direction perpendicular to the paper surface of FIG. 2) of the induction heat portion 25, is disposed on the coil bobbin 27. The coil 29 is connected to a not-shown power supply. Besides, the securing of the coil 29 to the coil bobbin 27 is performed by using, for example, a heat resistant adhesive (e.g., a silicone adhesive).

The center core 30a is a ferrite core that is disposed at a center of the coil 29 and has a rectangular shape in section. A pair of the arch cores 30b and a pair of the side cores 30c are disposed at both sides of the center core 30a. The arch cores 30b at both sides are a ferrite core which has a symmetrical shape with respect to the center core 30a and whose sectional shape is formed into an arch shape. The total length of each arch core 30b is longer than a region where the coil 29 is disposed. Besides, the side cores 30c at both sides are a ferrite core that is formed into a block shape. The side core 30c is disposed to be connected to one end (upper and lower ends in FIG. 2) of each arch core 30b. Each side core 30c covers an outside of the region where the coil 29 is disposed.

The arch core 30b is disposed at a plurality of positions at intervals in the longitudinal direction of the induction heat portion 25, for example. In the present embodiment, the interval of adjacent arch cores 30b is about 10 mm. Besides, the higher the disposition density of the arch cores 30b is, the better the induction performance of magnetic flux becomes. However, even if the disposition density of the arch core 30b is somewhat reduced, a decline of the induction performance of magnetic flux is a little, accordingly, it is preferable to set the disposition density of the arch cores 30b such that a high cost performance is obtained in a range where a sufficient performance is demonstrated. Besides, in a case where a temperature distribution of the fixing belt 21 in the width direction is adjusted, the disposition density of the arch cores 30b is adjusted.

Besides, the side core 30c is divided into a plurality of sections in the longitudinal direction of the induction heat portion 25, and one section has a length of about 30 to 60 mm. The plurality of side cores 30c are disposed consecutively with no gap in the longitudinal direction of the induction heat portion 25. The total length of the range where the side cores 30c are disposed corresponds to the length of the region where the coil 29 is disposed. As described above, by consecutively disposing the plurality of side cores 30c, there is an effect of leveling a fluctuation size of the temperature distribution due to the disposition of the arch core 30b. Meanwhile, the dispositions of each arch core 30b and side core 30c are decided in accordance with a magnetic flux density (magnetic field intensity) distribution of the coil 29, for example. The arch cores 30b are disposed at some interval, accordingly, the side core 30c compensates for an effect of collecting the magnetic flux at a position where the arch core 30b is not present and levels the magnetic flux distribution (temperature distribution) in the longitudinal direction.

The induction heat portion 25 supplies a high-frequency electric current to the coil 29 to generate the magnetic flux via the center core 30a and the arch core 30b and side core 30c at both sides. The magnetic flux output from the induction heat portion 25 acts on the induction heat generation layer of the fixing belt 21. As a result of this, an eddy current occurs around the magnetic flux of the induction heat generation layer, accordingly, Joule heat occurs thanks to electric resistance in the induction heat generation layer and the fixing belt 21 generates heat.

The electric current flowing in the coil 29 is controlled by the thermistor such that the fixing belt 21 has a predetermined temperature. And, when the fixing belt 21 is heated by the induction heat portion 25 to rise to the predetermined temperature, the paper sheet P (see FIG. 1) sandwiched by the fixing nip portion N is heated and pressurized by the pressure roller 23. According to this, the powder-state toners on the paper sheet P are melted and fixed.

A separation plate 35 for separating the paper sheet from the fixing belt 21 and a separation plate holder 37 for supporting the separation plate 35 are disposed in a downstream side with respect to the fixing nip portion N in a paper sheet convey direction (direction from lower to upper in FIG. 2). In the present embodiment, the separation plate 35 having a length of 336 mm, which is obtained by applying fluororesin coating to a surface of a stainless plate having a thickness of 0.1 mm, is mounted on the separation plate holder 37 that is formed of stainless and has a thickness of 1.2 mm.

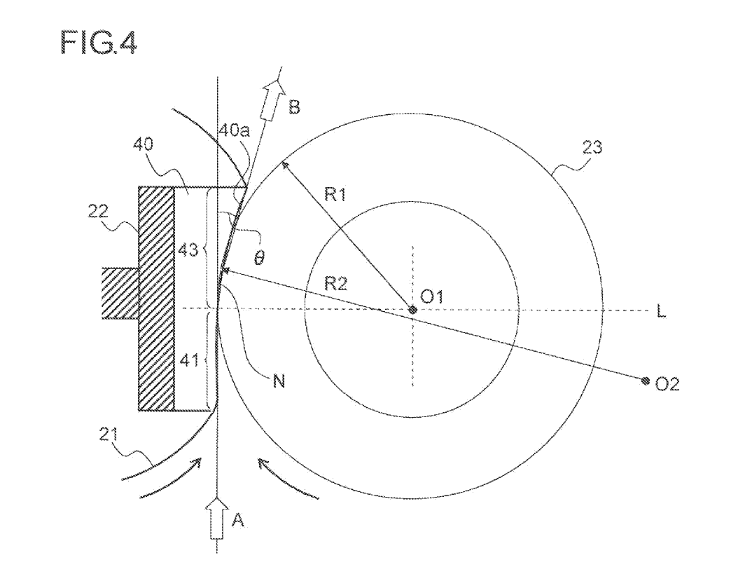

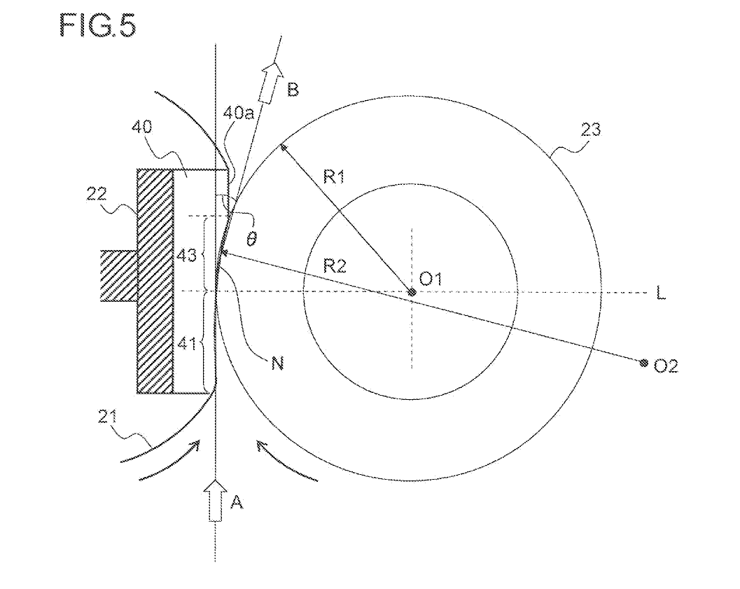

FIG. 4 is a side enlarged view around the fixing nip portion N in FIG. 3. By using FIG. 4, a structure of the push pad 40 used in the fixing device 13 is described in detail. As shown in FIG. 4, a slide surface (opposite surface) of the push pad 40 contacting the inner surface of the fixing belt 21 has a flat portion 41 substantially parallel to the paper sheet convey direction (arrow A direction in the figure) in the upstream side of the fixing nip portion N and an arc-shaped portion 43 bending toward the pressure roller 23 in the more downstream side than the flat portion 41 in the paper sheet convey direction. The pressure roller 23 is pushed against the arc-shaped portion 43 via the fixing belt 21, whereby the fixing nip portion N is formed. According to the above structure, without deteriorating a conveyance performance for the paper sheet, it is possible to secure a contact width (fixing nip width) between the push pad 40 and the pressure roller 23 and stabilize a fixing performance.

Besides, the arc-shaped portion 43 has a radius R2 of curvature larger than a radius R1 of curvature of the pressure roller 23, accordingly, it is possible to make a pressurizing force of the fixing nip portion N smaller from the upstream side to the downstream side in the paper sheet convey direction. Accordingly, the deformation of the push pad 40 due to the heat of the fixing belt 21 and the pressure of the pressure roller 23 becomes unlikely to occur and it is possible to keep the paper sheet separation performance in the downstream end portion of the fixing nip portion N over a long time.

Further, a center O2 of curvature of the arc-shaped portion 43 is disposed in a more upstream side than a straight line L that passes a center O1 of curvature of the pressure roller 23 and is perpendicular to the paper sheet convey direction, accordingly, the paper sheet passing the fixing nip portion N is conveyed in a direction (arrow B direction) approaching the pressure roller 23 along the arc-shaped portion 43. According to this, it is possible to alleviate the paper sheet clinging to the fixing belt 21 during a one-side printing time.

Besides, the pressure roller 23 may also be pushed against a part of the flat portion 41 via the fixing belt 21 at a predetermined pressure. According to this structure, the fixing nip portion N, where the flat portion 41 and the arc-shaped portion 43 continue in this order from the upstream side in the paper sheet convey direction, is formed, accordingly, the paper sheet entering the fixing nip portion N first passes the flat portion 41, thereafter, passes the arc-shaped portion 43. Accordingly, the paper sheet is stably insertable from the flat portion 41 into the fixing nip portion N. Besides, when passing the arc-shaped portion 43, the toners on the paper sheet are somewhat melted and fixed, accordingly, the fixed image becomes unlikely to be illegible when passing the arc-shaped portion 43 where the nip pressure is liable to fluctuate.

And, the arc-shaped portion 43 is further extended from the downstream end of the fixing nip portion N toward the downstream side in the paper sheet convey direction while keeping the radius R2 of curvature. According to this, an end portion of the push pad 40 in the downstream side in the paper sheet convey direction gradually goes away from the surface of the pressure roller 23, accordingly, it is possible to surely avoid a bite of the end portion of the push pad 40 in the downstream side in the paper sheet convey direction into the surface of the pressure roller 23. Accordingly, it is possible to more raise the paper sheet separation performance at the downstream end portion of the fixing nip portion N.

Meanwhile, here, the arc-shaped portion 43 is extended toward the downstream side in the paper sheet convey direction while keeping the radius R2 of curvature, however, as shown in FIG. 5, the arc-shaped portion 43 may be extended substantially in parallel with the flat portion 41 (the paper sheet convey direction in the upstream side of the fixing nip portion N) from the downstream end portion of the fixing nip portion N toward the downstream side in the paper sheet convey direction.

Besides, the paper sheet passing the fixing nip portion N is conveyed along the arc-shaped portion 43 of the push pad 40 at a predetermined angle to the paper sheet convey direction in the upstream side of the fixing nip portion N. A table 1 shows a relationship between the angle θ of the paper sheet convey direction (arrow B direction) in the downstream side to the paper sheet convey direction (arrow A direction) in the upstream side of the fixing nip portion N and the paper sheet separation performance. In the table 1, a case where the paper sheet separation performance is good is indicated by ∘, a case where the paper sheet separation performance deteriorates somewhat but has no problem in practical use is indicated by Δ, and a case where the paper sheet clings to the fixing belt 21 or the pressure roller 23 is indicated by ×.

TABLE 1

| | θ (°) | | | | | | | |
|---|---|---|---|---|---|---|---|---|
| | 3 | 5 | 8 | 10 | 12 | 15 | 17 | 20 |
| separation | X | X | Δ | ◯ | ◯ | ◯ | Δ | X |
| characteristic | | | | | | | | |

As shown in the table 1, in a case where the angle 0 is equal to or smaller than 5°, during a one-side printing time, the cling of the paper sheet passing the fixing nip portion N to the fixing belt 21 occurs. On the other hand, in a case where the angle θ is equal to or larger than 20°, during a both-side printing time, the cling of the paper sheet passing the fixing nip portion N to the pressure roller 23 occurs. In contrast to this, in a case where the angle θ is from 8° to 17°, the separation performance having no problem in practical use is obtained, especially, in a case of 10° to 15°, the good separation performance is obtained. From the above results, it is preferable to set the angle 0 in the range of 8° to 17°, and more preferable to set the angle θ in the range of 10° to 15°.

Besides, the present disclosure is not limited to the above embodiment, and it is possible to make various modifications without departing from the spirit of the present disclosure. For example, in the above embodiment, the push member 22 is secured to and supported by the support member 24, however, the push member 22 may be disposed separately from the support member 24 and supported by the fixing housing or the like.

Besides, the structures of the fixing belt 21 and pressure roller 23 described in the above embodiment are preferred examples, and it is also possible to employ other structures that allow the object of the present disclosure. Besides, instead of the induction heat portion 25, another heat portion such as a halogen lamp or the like may be disposed.

Besides, the fixing device in the present disclosure is not limited to the color printer 100 of tandem type shown in FIG. 1, and is applicable to various image forming apparatuses that use the electro-photographic process such as a digital multi-function machine, a color copy machine, an analog monochrome copy machine, or a monochrome printer, a facsimile and the like.

The present disclosure is usable in a fixing device of belt fixing type in which a recording medium is inserted into a fixing nip portion formed by a fixing belt and a pressure roller that butts the fixing belt at a predetermined pressure and an unfixed toner image is fixed. By using the present disclosure, it is possible to provide a fixing device which is able to alleviate deformation of a push pad that pushes a fixing belt, keep a shape of the fixing nip portion between the fixing belt and the pressure roller over a long time, and also secure a good separation performance for a recording medium during a fixing time.

What is claimed is:

1. A fixing device comprising:
a fixing belt that is an endless belt and rotatable at a speed substantially equal to a convey speed of a recording medium;
a heat portion that heats the fixing belt;
a pressure roller that is disposed to oppose an outer circumferential surface of the fixing belt and gives a rotation-drive force to the fixing belt;
a push member that contacts an inside of the fixing belt to push the fixing belt against the pressure roller at a predetermined pressure; and
a push pad that is disposed on a surface of the push member which opposes the fixing belt, includes a slide surface on which an inner circumferential surface of the fixing belt slides, the slide surface includes a flat portion substantially parallel to a convey direction of the recording medium and an arc-shaped portion that bends toward the pressure roller in a more downstream side than the flat portion in the convey direction with respect to the recording medium, the arc-shaped portion includes a radius R2 of curvature larger than a radius R1 of curvature of the pressure roller and a center O2 of curvature that is situated in a more upstream side than a straight line which passes through a center O1 of curvature of the pressure roller and is perpendicular to the convey direction of the recording medium; wherein
the recording medium is inserted into a fixing nip portion formed by the pressure roller butting the arc-shaped portion via the fixing belt at a predetermined pressure, whereby an unfixed toner image carried on the recording medium is fixed.

2. The fixing device according to claim 1, wherein
the pressure roller butts the flat portion as well besides the arc-shaped portion via the fixing belt at a predetermined pressure, and the fixing nip portion is formed such that the flat portion and the arc-shaped portion become continuous from an upstream side in the convey direction of the recording medium.

3. The fixing device according to claim 1, wherein
the arc-shaped portion is extended toward a downstream side of the fixing nip portion to keep the radius R2 of curvature or to be substantially parallel to the convey direction of the recording medium in an upstream side of the fixing nip portion.

4. The fixing device according to claim 1, wherein
an angle between the convey direction of the recording medium in an upstream side of the fixing nip portion and the convey direction of the recording medium in a downstream side of the fixing nip portion is 8° to 17°.

5. The fixing device according to claim 1, wherein
the push pad is formed of a liquid crystal polymer resin.

6. An image forming apparatus comprising:
a fixing device including:
a fixing belt that is an endless belt and rotatable at a speed substantially equal to a convey speed of a recording medium;
a heat portion that heats the fixing belt;
a pressure roller that is disposed to oppose an outer circumferential surface of the fixing belt and gives a rotation-drive force to the fixing belt;
a push member that contacts an inside of the fixing belt to push the fixing belt against the pressure roller at a predetermined pressure; and
a push pad that is disposed on a surface of the push member which opposes the fixing belt, includes a slide surface on which an inner circumferential surface of the fixing belt slides, the slide surface includes a flat portion substantially parallel to a convey direction of the recording medium and an arc-shaped portion that bends toward the pressure roller in a more downstream side than the flat portion in the convey direction with respect to the recording medium, the arc-shaped portion includes a radius R2 of curvature larger than a radius R1 of curvature of the pressure roller and a center O2 of curvature that is situated in a more upstream side than a straight line which passes through a center O1 of curvature of the pressure roller and is perpendicular to the convey direction of the recording medium; wherein
the recording medium is inserted into a fixing nip portion formed by the pressure roller butting the arc-shaped portion via the fixing belt at a predetermined pressure, whereby an unfixed toner image carried on the recording medium is fixed;
an image forming portion that forms a toner image; and
a transfer portion that transfers the toner image formed by the image forming portion onto the recoding medium as the unfixed toner image.
